(19) United States
(12) Patent Application Publication
(10) Pub. No.: US 2018/0014457 A1
(43) Pub. Date: Jan. 18, 2018

(54) RESEARCH SEED PLANTER CALIBRATION

(71) Applicant: Juniper Systems, Inc., Logan, UT (US)

(72) Inventors: Alex Kent Mertlich, Wellsville, UT (US); Ryan Justin Bates, Smithfield, UT (US)

(21) Appl. No.: 15/652,876

(22) Filed: Jul. 18, 2017

Related U.S. Application Data
(60) Provisional application No. 62/363,663, filed on Jul. 18, 2016.

(51) Int. Cl. A01C 7/10; A01C 7/04; A01C 21/00

(52) U.S. Cl. CPC A01C 7/107; A01C 21/005; A01C 7/046; A01C 7/105

(57) ABSTRACT

In an example, a method to calibrate a research seed planter may include transferring seeds through the research seed planter. The method may also include automatically measuring, using the research seed planter and without requiring a user to make manual measurements, at least one of the following: an actual first seed elapsed time; an actual last seed elapsed time; or an actual seed spacing between seeds. The method may also include adjusting, based on the automatically measuring, a calibration parameter of the research seed planter that contributes to seed placement by the research seed planter.

### CROSS-REFERENCE TO RELATED APPLICATION

This application claims the benefit of and priority to U.S. Provisional App. No. 62/363,663, filed Jul. 18, 2016, which is incorporated herein by reference in its entirety.

### FIELD

Some embodiments described herein generally relate to research seed planter calibration.

### BACKGROUND

Unless otherwise indicated herein, the materials described herein are not prior art to the claims in the present application and are not admitted to be prior art by inclusion in this section.

Some companies in the agricultural seed industry regularly plant research plots to evaluate certain seed varieties. Such seed varieties may include seeds from a specific source, genotype, and/or breeding line. In such a manner, researchers may evaluate characteristics of plants growing in the research plot, as well as characteristics of any crops produced from the plants.

Each seed variety may be planted in a different plot from other seed varieties, where each plot is separated by alleys from adjacent plots. Some research seed planters are global positioning system (GPS)-enabled. GPS may be used to track location of the research seed planters as passes are made through a field so the research seed planter knows when it is in or approaching a given plot or alley.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some example embodiments described herein generally relate to research seed planter calibration.

In an example embodiment, a method to calibrate a research seed planter may include transferring seeds through the research seed planter. The method may also include automatically measuring, using the research seed planter and without requiring a user to make manual measurements, at least one of the following: an actual first seed elapsed time; an actual last seed elapsed time; or an actual seed spacing between seeds. The method may also include adjusting, based on the automatically measuring, a calibration parameter of the research seed planter that contributes to seed placement by the research seed planter.

Additional features and advantages of the disclosure will be set forth in the description which follows, and in part will be obvious from the description, or may be learned by the practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth hereinafter.

### BRIEF DESCRIPTION OF THE DRAWINGS

To further clarify the above and other advantages and features of the present disclosure, a more particular description of the disclosure will be rendered by reference to specific embodiments thereof which are illustrated in the appended drawings. It is appreciated that these drawings depict only typical embodiments of the disclosure and are therefore not to be considered limiting of its scope. The disclosure will be described and explained with additional specificity and detail through the use of the accompanying drawings in which:

FIG. 1 shows a schematic drawing of portions of a seed planter;

FIG. 2 is a detail schematic drawing of a portion of the seed planter of FIG. 1;

FIG. 3A includes a graphical representation of an example calibration wizard that may be implemented to calibrate the seed planter of FIG. 1;

FIG. 3B is a flowchart of an example method to calibrate a research seed planter;

FIG. 4 is a flowchart of an example staging open transition time (OTT) calibration method;

FIG. 5 is a flowchart of an example evacuation OTT calibration method;

FIG. 6 is a flowchart of an example evacuation open state time (OST) calibration method; and

FIG. 7 is a flowchart of an example rotational speed calibration method,

all arranged in accordance with at least one embodiment described herein.

### DETAILED DESCRIPTION OF SOME EXAMPLE EMBODIMENTS

In some research seed planters, a user manually loads seeds, e.g., from a seed envelope or package, into a seed staging area of the research seed planter. Various electronics and/or mechanical elements determine how and when seeds from the seed staging area enter a seed transfer path that carries seeds through the research seed planter to be dropped in the field. With the research seed planter in motion as it makes passes through the field across the various plots, operation of the electronics and/or mechanical elements has to be properly timed in view of speed and location of the research seed planter to ensure each seed variety is planted in a desired one of the plots and without running into the alleys and/or without overlapping with other plots. Accordingly, research seed planters may be calibrated to determine and/or adjust timing of operation of the various electronics and/or mechanical elements.

According to one research seed planter calibration method, a field is manually measured and start and stop boundaries of each plot and alley are manually marked, e.g., with flags, spray paint, or other markers. The research seed planter takes a pass through the field and then a user manually measures how far off start and stop points (e.g., first and last seeds) of a planted row of seeds are from the start and stop boundaries of a corresponding plot. If the start point or stop point of the planted row is in front of or behind the start boundary or the stop boundary of the corresponding plot, the user has to decide which parameter of the research planter to adjust and by how much. For instance, if the start point of the planted row is a distance D after the start boundary of the corresponding plot, the user may have to increase a time in advance of reaching the start boundary at which a gate of the seed staging area is opened by a value that depends on the speed of the research seed planter. The user may have to take the research seed planter through multiple passes while taking manual measurements after each pass and manually adjusting one or more calibration parameters before getting the research seed planter properly calibrated.

In comparison, some embodiments described herein allow a research seed planter to be calibrated without the user taking any manual measurements or making any determinations or manual adjustments with respect to any adjustable calibration parameters. The calibration method may be implemented while the research seed planter is stationary. Alternatively or additionally, the calibration method may be implemented while the research seed planter is in motion.

Reference will now be made to the drawings to describe various aspects of some example embodiments of the disclosure. The drawings are diagrammatic and schematic representations of such example embodiments, and are not limiting of the present disclosure, nor are they necessarily drawn to scale.

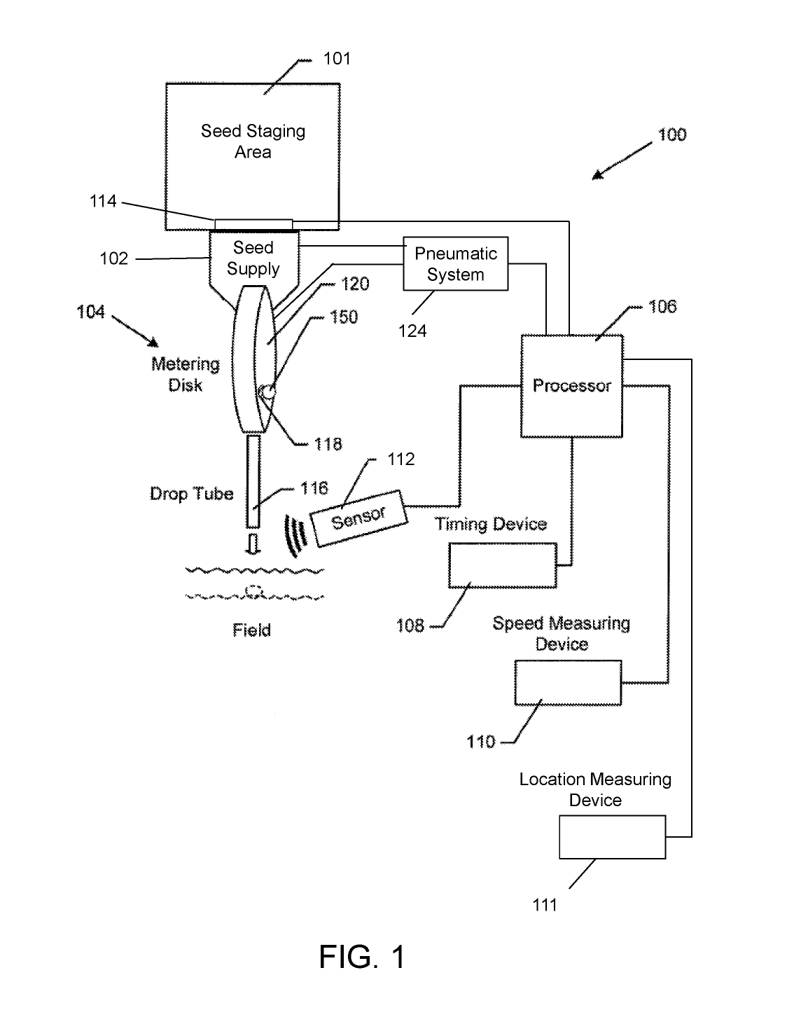

FIG. 1 shows a schematic drawing of portions of a seed planter 100, arranged in accordance with at least one embodiment described herein. In FIG. 1, the seed planter 100 is a research seed planter, however in other embodiments the seed planter 100 may be any other type of seed planter, such as a commercial seed planter. In general, the seed planter 100 includes a seed staging area 101, a seed supply 102, a seed transfer device 104, a processor 106, a timing device 108, a speed measuring device 110, and a location measuring device 111. The seed planter 100 of FIG. 1 also includes a seed sensor 112.

The seed planter 100 may be pulled behind a mobile planter transport device operated by an operator. Examples of mobile planter transport devices include farm tractors, all terrain vehicles (ATVs), livestock (horses, mules, donkeys), and multipurpose vehicles (e.g., Unimog or Humvee). In other embodiments the seed planter 100 may be self-propelled, such as, for example, by including an integrated transport mechanism or device.

The seed planter 100 may be configured to simultaneously plant any number X of rows of seeds, such as one row of seeds up to sixteen rows of seeds or more. For X>1, at least some components of the seed planter 100 may be duplicated X times to accommodate all X rows. For instance, the seed planter 100 may have X seed staging areas 101, X seed supplies 102, X seed transfer devices 104, and X seed sensors 112.

The seed staging area 101 includes a staging gate 114 that separates the seed staging area 101 from the seed supply 102. Groups of seeds may be deposited one group at a time in the seed staging area 101 in advance of the seed planter 100 reaching a corresponding plot in which the group of seeds is to be planted, or at any other time. In some embodiments, each group may be deposited in the seed staging area 101 manually by a user. In other embodiments, each group may be deposited in the seed staging area 101 automatically.

The staging gate 114 of the seed staging area 101 may be communicatively coupled to the processor 106. The processor 106 may send a signal or signals to the staging gate 114 to open the staging gate 114 to transfer seeds 150 of the corresponding group of seeds in the seed staging area 101 to a seed transfer path of the seed planter 100. The seed transfer path may include the seed supply 102, the seed transfer device 104, and a drop tube 116 in this example. The processor 106 may also send a signal or signals to close the staging gate 114 to allow another group of seeds to be deposited in the seed staging area 101 while preventing the other group of seeds from being transferred to the seed supply 102. Seeds 150 in the seed supply 102 may be singulated by the seed transfer device 104 as described in more detail below.

The seed transfer device 104 is configured to release individual seeds 150 through a drop tube 116 and into a field. The term “field” includes any area of land into which one or more seeds 150 are planted. Each field may include a single plot with an alley on one or more sides and/or or multiple plots separated and/or surrounded by alleys. In some embodiments, a field may include one or more research plots. In other embodiments, a field may represent one or more commercial plots. In still other embodiments, a field may represent a combination of one or more research and commercial plots.

The term “seed transfer device” and other forms thereof may represent any device configured to transfer seeds from a seed supply for the purpose of planting the seeds in a field. Such devices may include seed transfer devices that are configured to singulate seeds such that individual seeds are planted in respective areas of a field. Such devices may include vacuum-type seed metering devices, cone-type seed metering devices, and any other suitable seed transfer devices.

In FIG. 1, the seed transfer device 104 is illustrated as a vacuum-type seed metering device that includes a metering disk 120 that includes multiple seed carrying features 118 (e.g., seed holes) angularly spaced around the metering disk 120 and proximate an outer perimeter of the metering disk 120. The seed transfer device 104 is configured to singulate and transfer individual seeds 150 proximate a drop tube 116, where the individual seeds 150 are released into the field. Although the seed transfer device 104 of the depicted embodiment is shown having a generally vertical orientation (e.g., with a horizontal axis of rotation), embodiments described herein may include seed transfer devices with any suitable orientation.

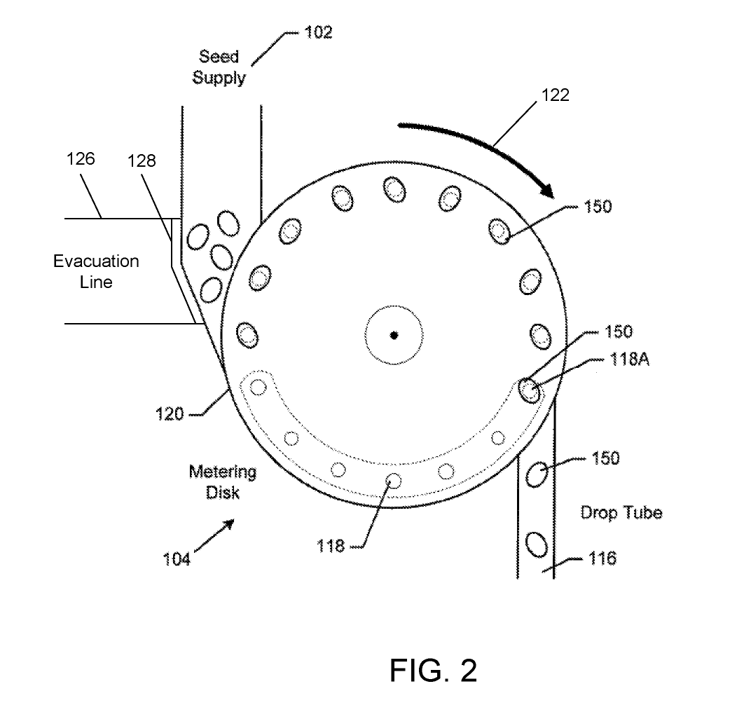

FIG. 2 is a detail schematic drawing of a portion of the seed planter 100 of FIG. 1, arranged in accordance with at least one embodiment described herein. In particular, FIG. 2 illustrates an example implementation of the seed supply 102, the seed transfer device 104 that includes the metering disk 104, and the drop tube 116. In operation, the metering disk 120 is configured to rotate past the seed supply 102 in a direction denoted at 122 to singulate the seeds 150 by picking up individual seeds 150 from the seed supply 102 and delivering the seeds 150 to the drop tube 116.

The seeds 150 may be released from the seed carrying features 118 of the metering disk 120 into the drop tube 116 in a variety of ways, such as by mechanically removing each seed 150 from the corresponding seed carrying feature 118 or interrupting negative pneumatic pressure at a seed carrying feature 118 positioned proximate the drop tube 116. In the depicted embodiment, the negative pressure of each seed carrying feature 118 is interrupted when it is positioned above the drop tube 116. The metering disk 120 includes the seed carrying features 118 that are configured to pick up individual seeds 150 and deliver the seeds 150 to the drop tube 116.

As illustrated in FIG. 2, the seed carrying features 118 include small apertures or holes that are sized to carry individual seeds 150. The apertures are in communication with a pneumatic system 124 (FIG. 1) to apply a vacuum so as to create localized areas of negative pneumatic pressure at the apertures. In such a manner, individual seeds 150 may be picked up from the seed supply 102 and delivered to the drop tube 116. The term “seed carrying feature” and other forms thereof may represent any other feature configured to deliver seeds and need not represent apertures. For example, some embodiments may utilize a seed transfer device in the form of a cone-type seed metering device, where the seed carrying features may represent individual pockets or grooves disposed about the periphery of the cone.

With combined reference to FIGS. 1 and 2, the pneumatic system 124 is pneumatically coupled to the seed supply 102 through an evacuation line 126. The evacuation line 126 may be selectively decoupled from the seed supply 102 by an evacuation line valve or gate 128. When the evacuation line valve or gate 128 is open and negative pneumatic pressure is supplied by the pneumatic system 124 to the evacuation line 126, seeds in the seed supply 102 may be evacuated from the seed supply 102. Thus, any excess seeds of a given type of seeds remaining in the seed supply 102 at the end of a plot may be evacuated so they are not planted outside the plot (e.g., in an alley or an adjacent plot).

In some embodiments, the seed carrying features 118 may be angularly spaced around the metering disk 120 (e.g., proximate the outer perimeter of the metering disk 120) at equal angular intervals. A rotational speed of the metering disk 120 may be selected and/or controlled by the processor 106. Some seed planters plant seeds at a target seed spacing. The value of the target seed spacing may be selected or input by a user. For a given angular spacing of the seed carrying features 118, a given translational speed of the seed planter 100, and a target seed spacing, the rotational speed of the metering disk 120 may be controlled to achieve the target seed spacing. A rotational speed calculated or determined for a given combination of angular spacing, target seed spacing, and translational speed (or target planted speed if the seed planter 100 is stationary) may be referred to as a target rotational speed. An actual rotational speed may not always match a target rotational speed. Embodiments described herein include calibration methods to reduce or eliminate mismatch between actual rotational speed and target rotational speed.

For instance, suppose the metering disk 120 includes 10 seed carrying features 118 equally angularly spaced around the metering disk 120, e.g., one seed carrying feature 118 every 36 degrees. Further suppose the translational speed of the seed planter 100 is 2 miles per hour (which is equal to 35.2 inches per second) and the target seed spacing is 5-inch spacing between seeds, which is equal to 142 milliseconds (ms) between seeds when moving at 35.2 inches per second. Accordingly, a target rotational speed of the metering disk 120 may be set at 36 degrees per 142 milliseconds, which is equal to about 42 revolutions per minute, to achieve the target seed spacing of 142 ms.

The foregoing discussion demonstrates an example of how distance can be translated to time and time can be translated to distance when a constant translational speed is assumed. Elsewhere herein distance may be discussed in terms of time and/or time may be discussed in terms of distance with the understanding that a constant translational speed is assumed in such circumstances.

Referring again to FIG. 1, the pneumatic system 124 is coupled to the metering disk 120 and to the seed supply 102. As generally described above, the pneumatic system 124 may supply negative pneumatic pressure to the seed carrying features 118 of the metering disk 120, with the negative pneumatic pressure being interrupted as each seed carrying feature 118 rotates into position proximate the drop tube 116 to release each seed 150 through the drop tube 116. In addition, the pneumatic system 124 is configured to selectively supply negative pneumatic pressure to the seed supply 102 to evacuate excess seeds 150 from the seed supply 102 responsive to a corresponding signal from the processor 106, as already described above. In particular, the processor 106 may send commands to open and close the evacuation line valve or gate 128 (FIG. 2) to supply or cutoff the negative pneumatic pressure to the evacuation line 126. The excess seeds may be evacuated from the seed supply 102 at or near the end of each row to keep alleys, e.g., between adjacent plots, free of seeds. The excess seeds may be evacuated to an excess seed receptacle (not shown). The pneumatic system 124 may include one or more air pumps or other devices suitable to generate negative pneumatic pressure, which devices may be pneumatically coupled to the metering disk 120 and the seed supply 102.

In the depicted embodiment, the processor 106 is in communication with and receives indications, signals, and/or data from the timing device 108, the speed measuring device 110, the location measuring device 111, and the seed sensor 112. In some embodiments, the timing device 108 is configured to generate timestamps and provide the timestamps to the processor 106. In some embodiments, the timing device 108 may include an electronic timer, a programmable logic controller (PLC), a personal computer (PC), a processor device, or other suitable timing device. Although illustrated as a discrete component from the seed sensor 112, in other embodiments the timing device 108 may be part of or included with the seed sensor 112. Alternatively or additionally, the timing device 108 may be configured to generate time differences between signals and to provide the time differences to the processor 106.

The speed measuring device 110 is configured to measure a speed of the seed planter 100 as it travels through the field and to provide the speed of the seed planter 100 to the processor 106. In some embodiments, a plurality of instantaneous speeds may be measured and provided to the processor 106. In other embodiments, the speed measuring device 110 may provide speed ranges, averages, or other statistical manipulations of the speed of the seed planter 100 as it travels through the field. In various embodiments the speed measuring device 110 may include one or more accelerometers, one or more velocimeters (including, but not limited to, laser velocimeters), one or more speedometers (including, but not limited to, eddy current or electronic speedometers), one or more cable systems, one or more dead reckoning systems, one or more encoders, one or more linear or rotary position sensors, one or more satellite navigation systems, one or more ground-based laser or other telemetry systems, and combinations thereof. An example of a cable system may include a cable that is wound about a spool and that includes position indicator buttons placed periodically along the length thereof. As the seed planter 100 is moved through the field, the cable is unwound and the position indicator buttons are sensed by a check-head or other sensing device. An example of a satellite navigation system may include the global positioning system (GPS) or the International Global Navigation Satellite System (GNSS) Service (IGS). GPS systems enable very accurate location determination or position fixing by utilizing measurements of precise timing signals broadcast from a constellation of more than two dozen GPS satellites in orbit around the earth. Locations can be determined, for example, in terms of longitude, latitude, and altitude regardless of time, weather and position on the earth. Other satellite navigation systems include IGS, which have incorporated NAVSTAR satellites of the United States and GLONASS satellites from Russia along with additional satellite constellations to provide robust navigation capability. In general, IGS provides increased precision in location determination and enables the utilization of enhancements in the capabilities of satellite navigation system devices. A Differential Global Positioning System (DGPS) is an enhancement of GPS that incorporates additional ground-based reference stations that allow the calculation of differences between the measured GPS positions and the ground-based fixed locations so that corrections can be made for improved accuracy. Accordingly, it should be understood that, as used herein, the term satellite navigation system is meant to encompass any of a number of different systems including, for example, GPS, IGS, GNSS, NAVSTAR, GLONASS, DGPS, etc.

The location measuring device 111 is configured to measure a location of the seed planter 100, and particularly of the drop tube 116. The location measuring device 111 may include one or more dead reckoning systems, one or more encoders, one or more linear or rotary position sensors, one or more satellite navigation systems, one or more ground-based laser or other telemetry systems, and combinations thereof. Although illustrated in FIG. 1 as being separate from the speed measuring device 110, in other embodiments the speed measuring device 110 and the location measuring device 111 may be combined as a single speed and location measuring device, such as a satellite navigation system. In some embodiments, the location measuring device 111 may be offset in front of the seed planter 100, e.g., on a tractor. In these and other embodiments, an offset (e.g., distance) may be measured between an antenna or other component of the location measuring device to a bottom of the drop tube 116, which offset may be entered into software to account for the offset so that locations are measured specifically for the drop tube 116. The offset distance may have one or both of a longitudinal component and/or a lateral component.

The seed sensor 112 is configured to sense the presence of each seed 150 as it is released into the field. Accordingly, the seed sensor 112 may be positioned so that it senses seeds 150 as they exit the drop tube 116. In other embodiments, the seed sensor 112 may be positioned so that it senses an area of the ground below the drop tube 116 so as to sense seeds 150 after they have been planted in the ground. Thus, the processor 106 may receive an indication from the seed sensor 112 for each seed 150 that is released into the field. In addition, the processor 106 may associate a timestamp from the timing device 108 with the indication of the presence of a seed 150 received into the field. The processor 106 may alternatively or additionally determine a location of at least a first seed 150 that is dropped into a row of a given plot and/or of a last seed that is dropped into the row of the given plot. Locations may be determined from the location measuring device 111.

In the depicted embodiment, the seed sensor 112 includes an optical sensor. Suitable optical sensors may include various beam sensors or retro-reflective sensors. In other embodiments the seed sensor 112 may be any other type of sensor configured to sense the presence or absence of a seed. For example, in some embodiments, the seed sensor 112 may include a capacitive proximity sensor. In other embodiments, the seed sensor 112 may include another type of sensor. For example, in some embodiments, one or more seeds 150 may be associated (such as being pre-coated, conditioned, treated, or coupled) with an element (such as an item, material, coating, or substance) that may be sensed by a non-optical sensor. For example, in some embodiments one or more seeds 150 may be coated with a metallic indicator substance that may be sensed by an inductive proximity or Hall-effect sensor.

In some embodiments, the seed sensor 112 is configured to output a signal and/or data to the processor 106 that indicates detection of each seed 150. The signal may be filtered to eliminate double counts that may occur when one of the seed carrying features 118 inadvertently picks up and drops in the drop tube 116 two seeds at once.

The processor 106 may include a processor of a personal computer (PC) in some embodiments. Alternatively or additionally, the processor 106 may be embodied as various processing means such as a processing element, a coprocessor, a controller or various other processing devices including integrated circuits such as, for example, an application specific integrated circuit (ASIC), a field programmable gate array (FPGA), a hardware accelerator, or other suitable processor. In an example embodiment, the processor 106 may be configured to execute instructions stored in a memory device or otherwise accessible to the processor 106. Alternatively or additionally, the processor 106 may be configured to execute hard coded functionality. As such, whether configured by hardware or software methods, or by a combination thereof, the processor 106 may represent an entity (e.g., physically embodied in circuitry) capable of performing operations according to embodiments described herein while configured accordingly. Thus, for example, when the processor 106 is embodied as an ASIC, FPGA or the like, the processor 106 may be specifically configured hardware for conducting the operations described herein. Alternatively, as another example, when the processor 106 is embodied as an executor of software instructions, the instructions may specifically configure the processor 106 to perform or control performance of the algorithms and/or operations described herein when the instructions are executed. However, in some cases, the processor 106 may be a processor of a specific device (e.g., a mobile terminal) adapted for employing embodiments described herein by further configuration of the processor 106 by instructions for performing or controlling performance of the algorithms and/or operations described herein. The processor 106 may include, among other things, a clock and logic gates configured to support operation of the processor 106.

An example method of normal operation of the seed planter 100 will be briefly described. As used herein, “normal operation” refers to operation of the seed planter 100 to plant seeds in a field after the seed planter 100 has been calibrated. The seed planter 100 is transported through a field which may include multiple plots separated by alleys, where a different variety of seeds is to be planted in each plot. The seed planter 100 may be transported through the field at a target planting speed that may be constant through the entire field or individual plots or that may be variable through the entire field or individual plots. Within a given plot, seeds may be dropped at the target seed spacing. As discussed above, the timing between drops depends on the translational speed of the seed planter 100, which translation speed may be equal to the target planting speed.

The seed planter 100 tracks its location within the field and a group of seeds to be planted in a given one of the plots may be loaded into the seed staging area 101 prior to reaching a start boundary line of a given plot. For example, the processor 106 may output through a user interface an instruction to a user to load the group of seeds into the seed staging area 101 prior to reaching the start boundary line of the given plot. At a trip point determined by the location measuring device 111, a timer (e.g., the timing device 108) starts timing. Various actual elapsed times discussed below are determined from when the timer starts timing. Elapsed times may be calculated in a variety of other ways and measuring from the trip point is provided as an example only.

The trip point may be a particular distance in advance of a start boundary of a plot. In an example embodiment, the trip point is one half a width of an alley in advance of the next plot. In some examples, an alley is 3 feet wide such that half the width is 1.5 feet. In this example, when the location measuring device 111 detects that the drop tube 116 is located at the trip point 1.5 feet from the start boundary of the plot, the location measuring device 111 sends a trip signal to the processor 106, which starts the timer.

At some time after receiving the trip signal, the processor 106 sends a command to open the staging gate 114 and the staging gate 114 is then opened to transfer a group of seeds from the seed staging area 101 into the seed transfer path beginning with the seed supply 102 so that the seeds 150 can be dropped into the field within the given plot. In particular, in the seed transfer path, seeds 150 are singulated by the metering disk 120 where the metering disk 120 meets the seed supply 102, singulated seeds 150 are rotated around the seed transfer device 104 by the metering disk 120 from the seed supply 102 to the drop tube 116, and then the singulated seeds 150 are released from the metering disk 120 at the drop tube 116 and dropped through the drop tube 116 into the given plot in the field.

At some other time after receiving the trip signal, the processor 106 also sends a command to evacuate any excess seeds of the group of seeds initially dropped into the seed staging area 101 from one or more locations of the seed transfer path. For instance, the processor 106 may send a command to open the evacuation line valve or gate 128 so that the negative pneumatic pressure generated by the pneumatic system 124 may reach and evacuate the excess seeds from the seed supply 102.

The time at which the command signal to open the staging gate 114 is sent may be timed so that a first seed of the group of seeds is dropped at the start boundary (within some tolerance) of the plot. Similarly, the time at which the command signal to open the evacuation line valve or gate 128 to evacuate excess seeds is sent may be timed so that a last seed of the group of seeds is dropped at the end boundary (within some tolerance) of the plot. Embodiments described herein include calibration methods to properly calibrate these and other timings and/or other calibration parameters. Calibration methods described herein may be implemented when the seed planter 100 is stationary, in which a translational speed of the seed planter 100 may be simulated by assuming a target planting speed. Alternatively or additionally, the calibration methods described herein may be implemented when the seed planter 100 is in motion using the actual translational speed, e.g., as measured by the speed measuring device 110.

An amount of time for a seed to travel from the seed supply 102 through the seed transfer device 104 and the drop tube 116 to exit the drop tube 116 may be referred to as an expected seed transfer duration. The expected seed transfer duration depends on a target rotational speed of the metering disk 120, an angle through which the seed is carried by the metering disk 120 from the seed supply 102 to the drop tube 116, and a length of the drop tube 116. The angle through which the seed is carried and the length of the drop tube 116 can be easily determined and/or saved as constants in a memory or other storage device accessible to the processor 106.

As described above, the target rotational speed depends on the translational speed of the seed planter 100 (or on a target planting speed when the seed planter 100 is stationary), the target seed spacing, and the angular spacing of the seed carrying features 118. Assuming the translational speed (or target planting speed), the target seed spacing, and the angular spacing of the seed carrying features 118 are known, the target rotational speed of the metering disk 120 can be determined. From the target rotational speed of the metering disk 120, the angle through which the seed is carried, and the length of the drop tube 116, the expected seed transfer duration may be calculated.

As mentioned previously, the trip signal is sent to the processor 106 by the location measuring device 111 when the location of the drop tube 116 is determined to be at the trip point, e.g., at a point that is a known distance from the start boundary of a plot. It is assumed that the trip point is the known distance from the start boundary of the plot and that the seed planter 100 is traveling at the target planting speed, even when the seed planter 100 is stationary. Based on these assumptions, the known distance can be translated to an elapsed time by dividing the known distance by the target planting speed. This elapsed time may be referred to as a target first seed elapsed time. A time at which the target first seed elapsed time begins may be referred to as a start time of the target first seed elapsed time since it is the time at which the timer begins in response to the trip signal. A time at which the target first seed elapsed time ends may be referred to as a target first seed drop time since it is the time at which a first seed of the group of seeds is expected to drop so as to drop at the start boundary of the plot.

Accordingly, the command to open the staging gate 114 has to be sent at least the expected seed transfer duration in advance of the target first seed drop time. If it is not sent at least that far in advance of the target first seed drop time, the first seed will drop after the start boundary of the plot. The expected seed transfer duration thus represents one delay that has to be accounted for when determining how far in advance of the target first seed drop time to send the command to open the staging gate 114.

There is additional delay that may be accounted for in addition to the expected seed transfer duration when determining how far in advance of the target first seed drop time to send the command to open the staging gate 114. The additional delay may include an aggregate amount of time: (1) to send the command to an actuator included as part of and that controls the staging gate 114, (2) to receive the command at the actuator, (3) to process the command at the actuator, (4) to activate the actuator to actually open the staging gate 114, and (5) for the seeds to drop through the staging gate 114 to a portion of the metering disk 120 located within the seed supply 102. The aggregate amount of time between sending the command to open the staging gate 114 and first seed uptake at the metering disk 120 may be referred to as a staging OTT parameter and may depend on one or more of the delays (1)-(5) above and/or one or more other delays not specifically listed. In these and other embodiments, the staging OTT parameter may depend on one or more variables which may or may not be known or easily modeled or calculated. More generally, the staging OTT parameter may be referred to as a first seed pickup delay parameter.

A sum of the expected seed transfer duration and the staging OTT parameter may be referred to as a first seed lead duration. The staging OTT parameter may be calibrated during staging OTT calibration so that the actual first seed drop time is equal or about equal to the target first seed drop time when the command to open the staging gate 114 is sent the first seed lead duration in advance of the target first seed drop time.

From one or more of the foregoing assumptions, a target last seed elapsed time and a target last seed drop time can also be determined. In particular, the target last seed elapsed time is the elapsed time it would take the drop tube 116 to travel from the trip point to the end boundary of the plot if traveling at the target planting speed. If it is assumed that the distance from the trip point to the start boundary of the plot is a known distance (e.g., half an alley width) and if a plot length (e.g., distance from start boundary to end boundary) is also assumed to be a known distance, a trip point-to-end boundary distance can be easily determined and the target last seed elapsed time can be calculated as the trip point-to-end boundary distance divided by the target planting speed. A time at which the target last seed elapsed time begins may be referred to as a start time of the target last seed elapsed time since it is the time at which the timer begins in response to the trip signal. In this example, the start time of the target last seed elapsed time is the same as the start time of the target first seed elapsed time. A time at which the target last seed elapsed time ends may be referred to as a target last seed drop time since it is the time at which a last seed of the group of seeds is expected to drop so as to drop at the end boundary of the plot.

Accordingly, the command to evacuate the excess seeds has to be sent at least the expected seed transfer duration in advance of the target last seed drop time. If it is not sent at least that far in advance of the target last seed drop time, the last seed will drop after the end boundary of the plot in a subsequent alley. The expected seed transfer duration thus represents one delay that has to be accounted for when determining how far in advance of the target last seed drop time to send the command to evacuate excess seeds.

There is additional delay that may be accounted for in addition to the expected seed transfer duration when determining how far in advance of the target last seed drop time to send the command to evacuate the excess seeds. As above, the additional delay may include an aggregate amount of time to send, receive, and process the command and actuate any mechanical elements (e.g., a solenoid that opens and closes the evacuation line valve or gate 128 of FIG. 2), as needed. The foregoing aggregate amount of time may be referred to as an evacuation OTT parameter. The evacuation OTT parameter may depend on one or more variables which may or may not be known or easily modeled or calculated. More generally, the evacuation OTT parameter may be referred to as an evacuation startup delay parameter.

A sum of the expected seed transfer duration and the evacuation OTT parameter may be referred to as a last seed lead duration. The evacuation OTT parameter may be calibrated during evacuation OTT calibration so that the actual last seed drop time is equal or about equal to the target last seed drop time when the command to evacuate excess seeds is sent the last seed lead duration in advance of the target last seed drop time.

An amount of elapsed evacuation time between sending the command to evacuate the excess seeds and sending a command to terminate evacuation may be determined by an evacuation OST parameter, more generally referred to as an evacuation duration parameter. In some embodiments, the amount of elapsed evacuation time is equal to the evacuation OST parameter. To fully evacuate excess seeds and ensure there are no remaining excess seeds after evacuation (referred to as “lingering seeds”), a longer evacuation OST parameter may be desired. However, to minimize any delay as the seed planter 100 crosses an alley between one plot and the next, a shorter elapsed evacuation time may be desired. The evacuation OST parameter may be calibrated during evacuation OST calibration to reduce or completely prevent lingering seeds without unduly extending the elapsed evacuation time. Embodiments described herein may be implemented to calibrate the evacuation OTT parameter to avoid evacuating seeds too early, and to calibrate the evacuation OST parameter to avoid lingering seeds.

As described above, the angular spacing of the seed carrying features 118 of the metering disk 120, the translational speed of the seed planter 100 (or the target planting speed when the seed planter 100 is stationary), and the target seed spacing together determine a target rotational speed of the metering disk 120. An actual rotational speed of the metering disk 104 may then be controlled by a pulse width modulation (PWM) signal from the processor 106 or other means to match the target rotational speed. In some embodiments, an actual seed spacing (e.g., calculated by the processor 106 in view of inputs from the seed sensor 112, the timing device 108, the speed measuring device 110, and/or the location measuring device 111) may not match the target seed spacing, in which case it may be desirable to adjust a corresponding parameter to cause the actual seed spacing to match the target seed spacing, at least within some threshold. In this regard, a fourth calibration parameter referred to as a rotational speed parameter may determine the actual rotational speed of the metering disk 120. The rotational speed parameter may be calibrated during rotational speed calibration so that the actual rotational speed is equal or about equal to the target rotational speed.

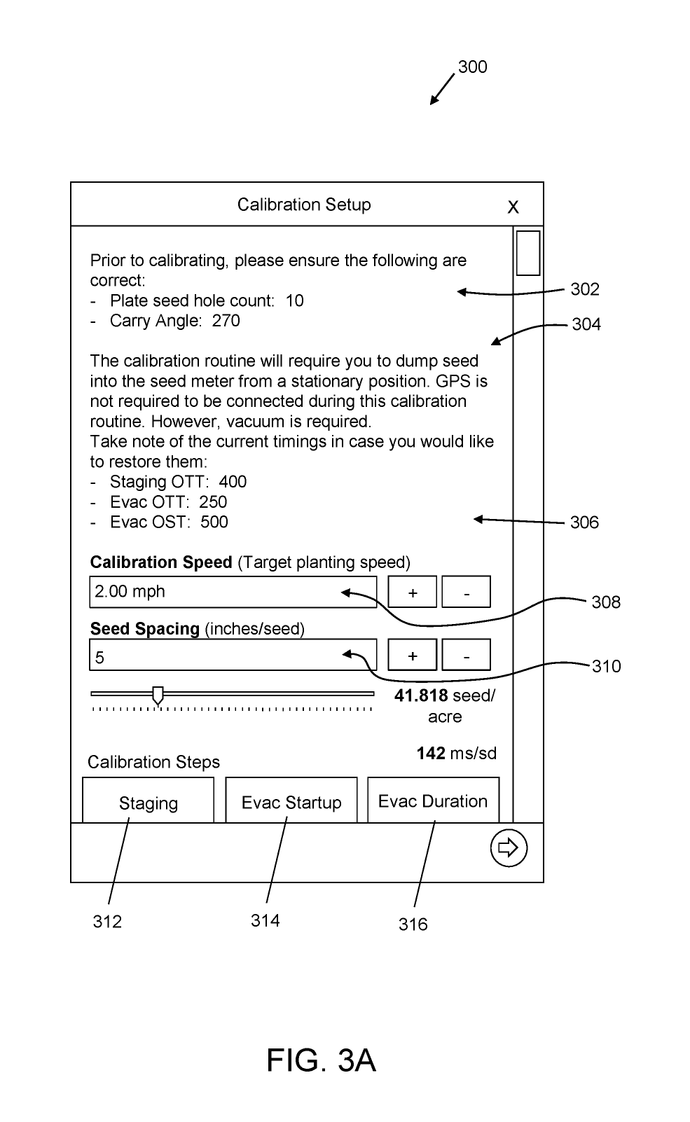

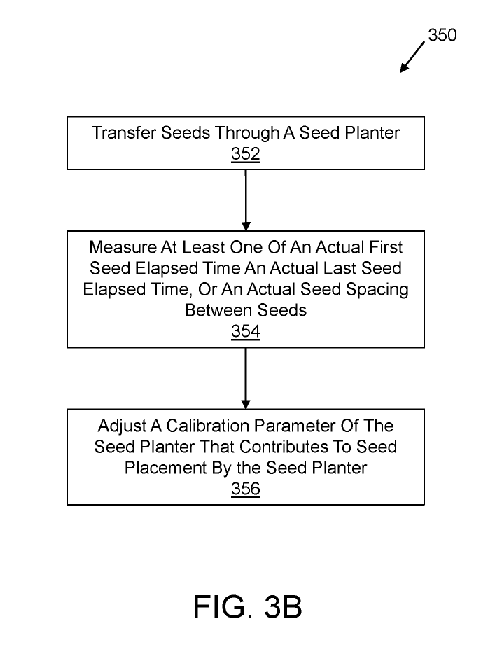

FIG. 3A includes a graphical representation of an example calibration wizard 300 that may be implemented to calibrate the seed planter 100 of FIG. 1, arranged in accordance with at least one embodiment described herein. The calibration wizard 300 includes a user interface that may be displayed on a display of a handheld or mobile electronic device and/or which may be coupled to a processor, such as the processor 106 of FIG. 1.

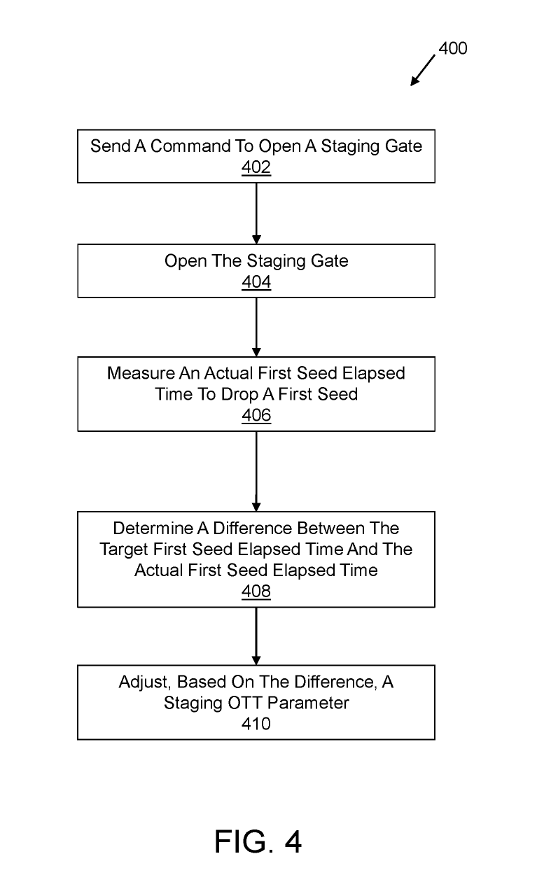

The calibration wizard 300 may include instructions 302 to verify certain assumptions about the seed planter 100, such as a number of seed carrying features 118 of the metering disk 120 and/or an orientation of the metering disk 120 (e.g., vertical in the example of FIG. 3A). The calibration wizard 300 may alternatively or additionally include instructions 304 regarding how to perform a calibration method that includes one or more of the methods of FIGS. 4-7 described below. The calibration wizard 300 may alternatively or additionally list one or more default values of the staging OTT parameter (“Staging OTT” in FIG. 3A), the evacuation OTT parameter (“Evac OTT” in FIG. 3A), the evacuation OST parameter (“Evac OST” in FIG. 3A), and/or the rotational speed parameter (not shown in FIG. 3A). The calibration wizard 300 may alternatively or additionally include fields 308 and 310 where a user can enter, respectively, a desired target planting speed (“Calibration Speed (Target planting speed)” in FIG. 3A) and a desired target seed spacing (“Seed Spacing (inches/seed)” in FIG. 3A). The calibration wizard 300 may alternatively or additionally include buttons 312, 314, 316 to perform different portions of the calibration method, including the button 312 to calibrate the staging OTT parameter, the button 314 to calibrate the evacuation OTT parameter, and the button 316 to calibrate the evacuation OST parameter.

The calibration method may be performed by or with a seed planter such as the seed planter 100 of FIG. 1. The calibration method may be performed while the seed planter is stationary. In these embodiments, planting speed of the seed planter may be simulated by translating between distance and time, as can be done when constant speed is assumed. For instance, a parameter such as seed spacing can be represented as a distance between adjacent seeds (or as a seed population or density) or as a timing between dropping adjacent seeds. Thus, even when the seed planter is stationary during performance of the calibration method, the actual seed spacing may be measured during the calibration method (to calibrate the rotational speed parameter) by measuring the elapsed time between dropping adjacent seeds. Alternatively or additionally, the calibration method may be performed while the seed planter is in motion, e.g., while moving at an actual translational speed.

FIG. 3B is a flowchart of an example method 350 to calibrate a seed planter, such as a research seed planter, arranged in accordance with at least one embodiment described herein. The method 350 may be performed, in whole or in part, by a processor device and/or a seed planter, such as the processor 106 and seed planter 100 of FIG. 1.

In general, the method 350 may include, at block 352, transferring seeds through the seed planter. For instance, seeds may be transferred from the seed staging area 101 through the seed supply 102, the seed transfer device 104 and the drop tube 116 to exit the drop tube.

The method 350 may also include, at block 354, measuring at least one of an actual first seed elapsed time, an actual last seed elapsed time, or an actual seed spacing between seeds. The measuring may be performed automatically by the seed planter and without requiring a user to make manual measurements. The measuring may be performed for multiple groups of seeds to obtain a statistically meaningful sample size.

The method 350 may also include, at block 356, adjusting, based on the automatically measuring, a calibration parameter of the seed planter that contributes to seed placement by the seed planter. For instance, the measurement may be compared to a target for the measurement (e.g., by calculating a difference between the measurement and the target) and a corresponding calibration parameter may be adjusted up or down based on the comparison and/or based on multiple comparisons between the target and multiple measurements over time.

Alternatively or additionally, adjusting the calibration parameter of the seed planter that contributes to seed placement by the seed planter at block 356 may include adjusting at least one of the first seed pickup delay parameter (e.g., staging OTT parameter), the evacuation startup delay parameter (e.g., evacuation OTT parameter), the evacuation duration parameter (e.g., evacuation OST parameter), and/or the rotational speed parameter. For instance, if a standard deviation derived from the measurements indicates that the seed planter has settled, e.g., the standard deviation derived from multiple actual first seed elapsed times, actual last seed elapsed times, or actual seed spacings is less than a tolerance threshold (such as less than a seed spacing), one or more of the calibration parameters may be adjusted. The calibration parameter adjusted at block 356 may include the first seed pickup delay, the evacuation startup delay parameter, the evacuation duration parameter, the rotational speed parameter, and/or other calibration parameter.

Steps associated with calibrating each of the parameters discussed above are discussed in turn below. Calibrations methods according to some embodiments may involve calibration of a single one of the calibration parameters discussed herein, a combination of any two or more of the calibration parameters discussed herein, up to all of the calibration parameters discussed herein.

### Staging OTT Calibration

FIG. 4 is a flowchart of an example staging OTT calibration method 400, arranged in accordance with at least one embodiment described herein. The method 400 may be performed, in whole or in part, by a processor device and/or a seed planter, such as the processor 106 and seed planter 100 of FIG. 1. The method 400 may begin at block 402.

At block 402, a command to open a staging gate may be sent. The command may be sent after a start time and before a target first seed drop time. The staging gate may include the staging gate 114 of FIG. 1. As described above, the start time may refer to a time at which a target first seed elapsed time begins, e.g., a time at which a trip signal is received. The target first seed elapsed time may refer to an expected elapsed time, assuming a target planting speed, to travel from a trip point to a start boundary of a plot. Thus, the target first seed elapsed time may also refer to an expected elapsed time between the start time and the target first seed drop time at which a first seed of a group of seeds is expected to drop so as to drop at the start boundary of the plot.

In some embodiments, sending the command to open the staging gate may include sending the command to open the staging gate a first seed lead duration in advance of the target first seed drop time. The first seed lead duration may be equal to the staging OTT parameter plus the expected seed transfer duration as described above. Some embodiments may additionally include calculating the expected seed transfer duration as an amount of time for a seed to travel from a start to an end of the seed transfer path (e.g., from the portion of the metering disk 120 within the seed supply 102 to the exit of the drop tube 116). Block 402 may be followed by block 404.

At block 404, the staging gate may be opened to transfer the group of seeds from a seed staging area to a seed transfer path. Stated another way, the staging gate may be opened to transfer the group of seeds from the seed staging area to the seed transfer path. The seed staging area may include the seed staging area 101 of FIG. 1, for example. The seed transfer path may include the seed supply 102, the seed transfer device 104, and the drop tube 116 of FIG. 1, for example. Block 404 may be followed by block 406.

At block 406, an actual first seed elapsed time may be measured, e.g., between the start time and an actual first seed drop time at which the first seed of the group of seeds drops from the seed transfer path. Block 406 may be followed by block 408.

At block 408, a difference between the target first seed elapsed time and the actual first seed elapsed time may be determined. The difference may be determined by subtracting one from the other. Block 408 may be followed by block 410.

At block 410, based on the difference, the staging OTT parameter may be adjusted to reduce future differences between the target first seed elapsed time and future actual first seed elapsed times. For instance, the staging OTT parameter may be adjusted by an amount equal to (or derived from) the difference: if the actual first seed elapsed time is longer than the target first seed elapsed time, the staging OTT parameter may be increased by an amount equal to the difference between the two; or if the actual first seed elapsed time is shorter than the target first seed elapsed time, the staging OTT parameter may be decreased by an amount equal to the difference between the two. In this and other embodiments, each of blocks 402, 404, 406, 408, and 410 may be repeated multiple times until, e.g., the difference is less than a tolerance threshold, such as one target seed spacing, or until some other criteria or threshold is met.

Alternatively, each of blocks 402, 404, 406, and 408 may be repeated for each of N−1 additional groups of seeds (in addition to the first group of seeds already discussed above in the context of FIG. 4) to determine a total of N differences between the target first seed elapsed time and N actual first seed elapsed times. A standard deviation of the N differences may be determined. If the standard deviation is too large, e.g., larger than a tolerance threshold, this may indicate the seed planter is not settled insofar as the actual first seed elapsed times are too spread out (as indicated by the standard deviation being greater than the tolerance threshold). In this case, suggested changes/adjustments/troubleshooting may be provided to a user to rectify the inconsistent actual first seed elapsed times before making adjustments to the staging OTT parameter. If the standard deviation is sufficiently small, e.g., less than the tolerance threshold, this may indicate that the seed planter has settled insofar as the actual first seed elapsed times are consistently about the same value (as indicated by the standard deviation being less than the tolerance threshold). Thus, the adjusting at block 410 may occur in response to the standard deviation of the N differences being less than the tolerance threshold.

Further, the adjusting, based on the differences at block 410 may include increasing or decreasing a value of the staging OTT parameter by an amount equal to an average of the N differences. The staging OTT parameter may be increased by the average of the N differences if an average of the N actual first seed elapsed times is greater than the target first seed elapsed time. On the other hand, the staging OTT parameter may be decreased by the average of the N differences if the average of the N actual first seed elapsed times is less than the target first seed elapsed time.

In some embodiments, the tolerance threshold is one target seed spacing. As described above, the staging OTT parameter directly contributes to actual first seed elapsed times since it, together with expected seed transfer duration, determines how far in advance of the target first seed drop time to send the command to open the staging gate 114. An amount of the adjustment to the staging OTT parameter may be equal in some embodiments to an average of the N differences.

Consider an example. Suppose N=7, the target planting speed is 2 miles per hour (which is equal to 35.2 inches per second), and the target seed spacing is 5-inch spacing between seeds (which is equal to 142 ms between seeds when moving at 35.2 inches per second). Further suppose that first, second, third, fourth, fifth, sixth, and seventh differences (N ith differences) between a target first seed elapsed time and first, second, third, fourth, fifth, sixth, and seventh actual first seed elapsed times are determined to be, respectively, 158 ms, 275 ms, 202 ms, 231 ms, 174 ms, 207 ms, and 219 ms. The standard deviation of these differences may be calculated by taking the square root of the average of the squared deviations of the differences from their average value. The standard deviation in this example is about 38 ms. Because the standard deviation of 38 ms is less than the threshold tolerance of 142 ms in this example, the staging OTT parameter may be adjusted. Insofar as the average of the first through seventh actual first seed elapsed times is longer than the target first seed elapsed time in this example, the staging OTT parameter may be adjusted by increasing its current value by the average of the first through seventh differences, or about 209 ms in this example.

However, suppose the standard deviation or other single staging value that represents the N ith differences is determined to be greater than 142 ms. Since the standard deviation that is greater than 142 ms exceeds the tolerance threshold of 142 ms in this example, the staging OTT parameter may not be adjusted; instead, suggested changes/adjustments/troubleshooting may be provided to a user to rectify the inconsistent actual first seed elapsed times before making adjustments to the staging OTT parameter.

### Evacuation OTT Calibration

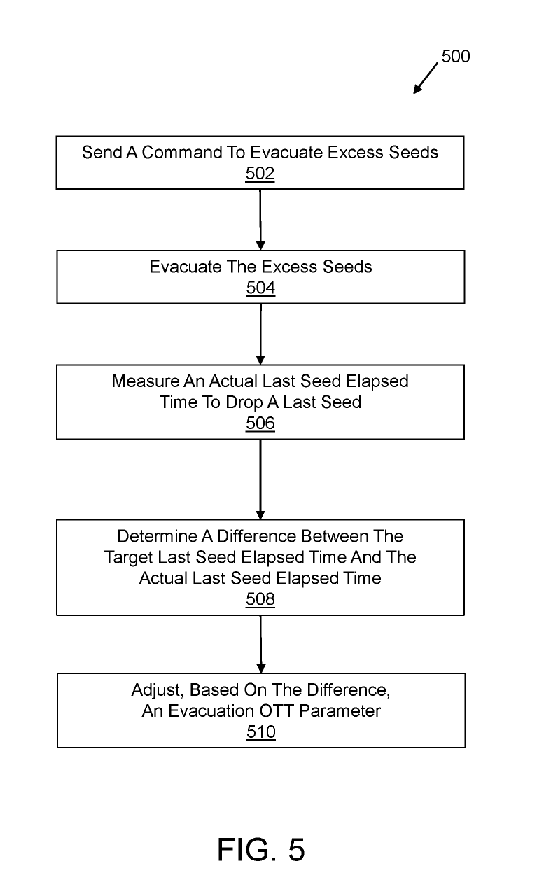

FIG. 5 is a flowchart of an example evacuation OTT calibration method 500, arranged in accordance with at least one embodiment described herein. The method 500 may be performed, in whole or in part, by a processor device and/or a seed planter, such as the processor 106 and seed planter 100 of FIG. 1. The method 500 may begin at block 502.

At block 502, a command to evacuate excess seeds of a second group of seeds from one or more locations in a seed transfer path of a seed planter may be sent. The group of seeds discussed with respect to FIG. 5 is referred to as a second group of seeds to distinguish it from the group of seeds discussed with respect to FIG. 4. The seed transfer path may include the seed supply 102, the seed transfer device 105, and the drop tube 116 of FIG. 1, for example. In some embodiments, the one or more locations from which excess seeds are evacuated may include the seed supply 102 of FIG. 1.

The command to evacuate excess seeds may be sent to the evacuation line valve or gate 128 of FIG. 2. The command may be sent after a start time and before a target last seed drop time that together define a target last seed elapsed time. As described above, the start time may refer to a time at which the target last seed elapsed time begins, e.g., a time at which a trip signal is received. The target last seed elapsed time may refer to an expected elapsed time, assuming a target planting speed, to travel from a trip point to an end boundary of a plot. Thus, the target last seed elapsed time may also refer to an expected elapsed time between the start time and the target last seed drop time at which a last seed of the second group of seeds is expected to drop so as to drop at the end boundary of the plot.

In some embodiments, sending the command to evacuate the excess seeds may include sending the command to evacuate the excess seeds a last seed lead duration in advance of the target last seed drop time. The last seed lead duration may be equal to the evacuation OTT parameter plus the expected seed transfer duration as described above. Some embodiments may additionally include calculating the expected seed transfer duration as an amount of time for a seed to travel from a start to an end of the seed transfer path (e.g., from the portion of the metering disk 120 within the seed supply 102 to the exit of the drop tube 116). Block 502 may be followed by block 504.

At block 504, the excess seeds of the second group of seeds may be evacuated from the one or more locations in the seed transfer path. To avoid lingering seeds, the evacuation OST parameter may be set relatively long (e.g., much longer than may be used during normal operation, such as 1 second) to ensure all excess seeds are removed during evacuation OTT calibration. Block 504 may be followed by block 506.

At block 506, an actual last seed elapsed time may be measured, e.g., between the start time and an actual last seed drop time at which the last seed of the second group of seeds drops from the seed transfer path. Block 506 may be followed by block 508.

At block 508, a difference between the target last seed elapsed time and the actual last seed elapsed time may be determined. The difference may be determined by subtracting one from the other. Block 508 may be followed by block 510.

At block 510, based on the difference, the evacuation OTT parameter may be adjusted to reduce future differences between the target last seed elapsed time and future actual last seed elapsed times. For instance, the evacuation OTT parameter may be adjusted by an amount equal to (or derived from) the difference: if the actual last seed elapsed time is longer than the target last seed elapsed time, the evacuation OTT parameter may be increased by an amount equal to the difference between the two; or if the actual last seed elapsed time is shorter than the target last seed elapsed time, the evacuation OTT parameter may be decreased by an amount equal to the difference between the two. In this and other embodiments, each of blocks 502, 504, 506, 508, and 510 may be repeated multiple times until, e.g., the difference is less than a tolerance threshold, such as one target seed spacing, or until some other criteria or threshold is met.

Alternatively, each of blocks 502, 504, 506, and 508 may be repeated for each of N−1 additional groups of seeds (in addition to the second group of seeds already discussed above in the context of FIG. 5) to determine a total of N differences between the target last seed elapsed time and N actual last seed elapsed times. A standard deviation of the N differences may be determined. If the standard deviation is too large, e.g., larger than a tolerance threshold, this may indicate the seed planter is not settled insofar as the actual last seed elapsed times are too spread out (as indicated by the standard deviation being greater than the tolerance threshold). In this case, suggested changes/adjustments/troubleshooting may be provided to a user to rectify the inconsistent actual last seed elapsed times before making adjustments to the evacuation OTT parameter. If the standard deviation is sufficiently small, e.g., less than the tolerance threshold, this may indicate that the seed planter has settled insofar as the actual last seed elapsed times are consistently about the same value (as indicated by the standard deviation being less than the tolerance threshold). Thus, the adjusting at block 510 may occur in response to the standard deviation of the N differences being less than the tolerance threshold.

Further, the adjusting, based on the differences at block 510 may include increasing or decreasing a value of the evacuation OTT parameter by an amount equal to an average of the N differences. The evacuation OTT parameter may be increased by the average of the N differences if an average of the N actual last seed elapsed times is greater than the target last seed elapsed time. On the other hand, the evacuation OTT parameter may be decreased by the average of the N differences if the average of the N actual last seed elapsed times is less than the target last seed elapsed time.

In some embodiments, the tolerance threshold is one target seed spacing. As described above, the evacuation OTT parameter directly contributes to actual last seed elapsed times since it, together with expected seed transfer duration, determines how far in advance of the target last seed drop time to send the command to evacuate the excess seeds. An amount of the adjustment to the evacuation OTT parameter may be equal in some embodiments to an average of the N differences between the N actual last seed elapsed times and the target last seed elapsed time.

Consider an example. Suppose N=7, the target planting speed is 2 miles per hour (which is equal to 35.2 inches per second), and the target seed spacing is 5-inch spacing between seeds (which is equal to 142 ms between seeds when moving at 35.2 inches per second). Further suppose that first, second, third, fourth, fifth, sixth, and seventh differences (N jth differences) between a target last seed elapsed time and first, second, third, fourth, fifth, sixth, and seventh actual last seed elapsed times are determined to be, respectively, 280 ms, 575 ms, 314 ms, 292 ms, 563 ms, 463 ms, and 308 ms. The standard deviation of these differences may be calculated by taking the square root of the average of the squared deviations of the differences from their average value. The standard deviation in this example is about 131 ms. Because the standard deviation of 131 ms is less than the threshold tolerance of 142 ms in this example, the evacuation OTT parameter may be adjusted. Insofar as the average of the first through seventh actual last seed elapsed times is longer than the target last seed elapsed time in this example, the evacuation OTT parameter may be adjusted by increasing its current value by the average of the first through seventh differences, or by about 399 ms in this example.

However, suppose the standard deviation or other single evacuation value that represents the N differences is determined to be greater than 142 ms. Since the standard deviation that is greater than 142 ms exceeds the tolerance threshold of 142 ms in this example, the evacuation OTT parameter may not be adjusted; instead, suggested changes/adjustments/troubleshooting may be provided to a user to rectify the inconsistent actual last seed elapsed times before making adjustments to the evacuation OTT parameter.

### Evacuation OST Calibration

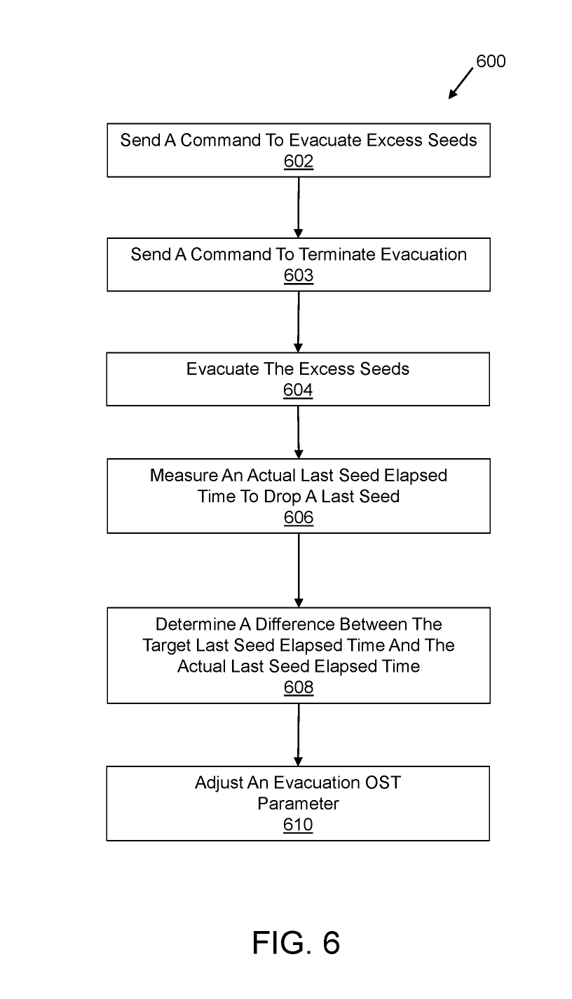

FIG. 6 is a flowchart of an example evacuation OST calibration method 600, arranged in accordance with at least one embodiment described herein. The method 600 may be performed, in whole or in part, by a processor device and/or a seed planter, such as the processor 106 and seed planter 100 of FIG. 1. The method 600 may begin at block 602.

At block 602, a command to evacuate excess seeds of a third group of seeds from one or more locations in a seed transfer path of a seed planter may be sent. The group of seeds discussed with respect to FIG. 6 is referred to as a third group of seeds to distinguish it from the groups of seeds discussed with respect to FIGS. 4 and 5. The seed transfer path may include the seed supply 102, the seed transfer device 106, and the drop tube 116 of FIG. 1, for example. In some embodiments, the one or more locations from which excess seeds are evacuated may include the seed supply 102 of FIG. 1.

The command to evacuate excess seeds may be sent to the evacuation line valve or gate 128 of FIG. 2 and may include a command to open the evacuation line valve or gate 128. The command may be sent after a start time and before a target last seed drop time that together define a target last seed elapsed time. As described above, the start time may refer to a time at which the target last seed elapsed time begins, e.g., a time at which a trip signal is received. The target last seed elapsed time may refer to an expected elapsed time, assuming a target planting speed, to travel from a trip point to an end boundary of a plot. Thus, the target last seed elapsed time may also refer to an expected elapsed time between the start time and the target last seed drop time at which a last seed of the kth group of seeds is expected to drop so as to drop at the end boundary of the plot. Block 602 may be followed by block 603.

At block 603, a command to terminate evacuation of the excess seeds may be sent after sending the command to evacuate excess seeds. The command to terminate evacuation may be sent to the evacuation line or gate 128 of FIG. 2 and may include a command to close the evacuation line valve or gate 128. A duration of time between sending the command to evacuate excess seeds and sending the command to terminate evacuation may be referred to as an elapsed evacuation duration time. The elapsed evacuation time may be equal to the evacuation OST parameter. In some embodiments, for instance, the processor 106 may wait to send the command to terminate evacuation until the elapsed evacuation time (which is equal to the evacuation OST parameter) has passed since sending the command to evacuate excess seeds. Block 603 may be followed by block 604.

At block 604, the excess seeds of the third group of seeds may be evacuated from the one or more locations in the seed transfer path until the command to terminate evacuation is implemented. Stated another way, excess seeds in the one or more locations (e.g., in the seed supply 102) of the seed transfer path may be evacuated until the mechanical elements that implement evacuation can receive, process, and implement the command to terminate evacuation. Block 604 may be followed by block 606.

At block 606, an actual last seed elapsed time for the third group of seeds may be measured, e.g., between the start time and an actual last seed drop time at which the last seed of the third group of seeds drops from the seed transfer path. Block 606 may be followed by block 608.

At block 608, a difference between the target last seed elapsed time and the actual last seed elapsed time for the third group of seeds may be determined. The difference may be determined by subtracting one from the other. In this regard, it is noted that if the evacuation OTT parameter has already been properly calibrated, a last seed to drop may be determined to be a lingering seed that results from inadequate elapsed evacuation time if the difference between the actual last seed elapsed time and the target last seed elapsed time is greater than, e.g., the tolerance threshold. Block 608 may be followed by block 610.

At block 610, the evacuation OST parameter may be adjusted. For instance, if the actual last seed elapsed time is within a tolerance threshold of the target last seed elapsed time, the evacuation OST parameter may be decreased by a fixed amount (e.g., 100 ms), or by half its current value (e.g., according to a binary search algorithm). On the other hand, if the actual last seed elapsed time is more than a tolerance threshold longer than the target last seed elapsed time, the evacuation OST parameter may be increased by a fixed amount, or by double its current value, or by a buffer amount, or by some other amount.

Alternatively or additionally, each of blocks 602, 603, 604, 606, and 608 may be repeated for each of N−1 additional groups of seeds (in addition to the third group of seeds already discussed above in the context of FIG. 6) to determine a total of N differences between the target last seed elapsed time and N actual last seed elapsed times. A standard deviation of the N differences may be determined. If the standard deviation is too large, e.g., larger than a tolerance threshold, this may indicate that the seed planter is not settled insofar as the actual last seed elapsed times are too spread out (as indicated by the standard deviation being greater than the tolerance threshold). In this case, suggested changes/adjustments/troubleshooting may be provided to a user to rectify the inconsistent actual last seed elapsed times before making adjustments to the evacuation OST parameter. If the standard deviation is sufficiently small, e.g., less than the tolerance threshold, this may indicate that the seed planter has settled insofar as the actual last seed elapsed times are consistently about the same value (as indicated by the standard deviation being less than the tolerance threshold). Thus, the adjusting at block 610 may occur in response to the standard deviation of the N differences being less than the tolerance threshold.

Further, the adjusting at block 510 may include increasing or decreasing a value of the evacuation OST parameter by, e.g., a fixed amount, by half its current value, or by some other amount. In some embodiments, the value of the evacuation OST parameter may be decreased in response to an average of the N actual last seed elapsed times being within the tolerance threshold from the target last seed elapsed time. In some embodiments, the value of the evacuation OST parameter may be increased in response to the average of the N actual last seed elapsed times being greater than the target last seed elapsed time by an amount greater than the tolerance threshold.

Alternatively or additionally, the process of performing each of blocks 602, 603, 604, 606, and 608 for N groups of seeds may be repeated for K sets (each having N groups of seeds) to determine, for each of the K sets, the standard deviation of N differences between the target last seed elapsed time and N actual last seed elapsed times for the corresponding set of N groups of seeds.

After performing blocks 602, 603, 604, 606, and 608 for all N groups of seeds in a corresponding one of the K sets, block 610 may be performed as described above. For instance, a value of the evacuation OST parameter may be decreased in response to an average of the N actual last seed elapsed times for the corresponding one of the K sets being less than the tolerance threshold from the target last seed elapsed time. Alternatively or additionally, the value of the evacuation OST parameter may be increased in response to the average of the N actual last seed elapsed times for the corresponding one of the K sets being greater than the target last seed elapsed time by an amount greater than the tolerance threshold.

In general, the evacuation OST parameter may have an initial value that is longer, and potentially much longer, than needed to evacuate all excess seeds. Thus, in some embodiments, block 610 for each of the first few sets of the K sets may involve decreasing the value of the evacuation OST parameter.

Eventually, the value of the evacuation OST parameter may be reduced too far (e.g., the evacuation duration may be too short) to fully evacuate all excess seeds, in which case an average of the N actual last seed elapsed times for one of the K sets may be longer than the target last seed elapsed time. In this case, the value of the evacuation OST parameter may be increased. For instance, the evacuation OST parameter may be increased back to its immediately preceding value. Optionally, a buffer amount may be added to the immediately preceding value. In some cases, no more sets of N groups of seeds may be processed after the evacuation OST parameter has been increased.

### Rotational Speed Calibration

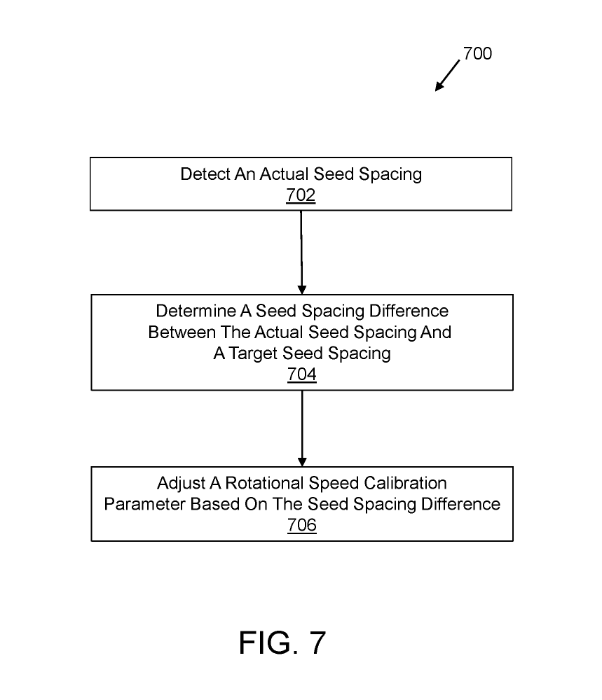

FIG. 7 is a flowchart of an example rotational speed calibration method 700, arranged in accordance with at least one embodiment described herein. The method 700 may be performed, in whole or in part, by a processor device and/or a seed planter, such as the processor 106 and seed planter 100 of FIG. 1. The method 700 may begin at block 702.

At block 702, an actual seed spacing between seeds in one or more group of seeds may be determined. For instance, actual seed spacing may be determined for the second and third groups of seeds discussed above with respect to FIGS. 5 and 6. For a given one of the groups of seeds, determining the actual seed spacing may include determining an actual average seed spacing of the seeds in the corresponding group of seeds by dividing a duration of time between an actual first seed drop time and an actual last seed drop time by M−1, where M is a detected number of dropped seeds of the ith group of seeds. In some embodiments, two or more seeds may be dropped from the same seed-carrying feature very close together in time if the seed-carrying feature has inadvertently picked up multiple seeds at the same time. In these and other embodiments, M may include a filtered detected number of seeds that has been filtered to count a single seed where multiple seeds are detected very close together in time. Very close together in time may include a duration of time less than a seed counting tolerance threshold, such as less than 50 ms, less than one quarter of the target seed spacing, or less than some other seed counting tolerance threshold. The above procedure may be implemented to calculate the actual seed spacing for each group of seeds individually, which individual measurements may then be combined (e.g., averaged) to determine the actual seed spacing at block 702. Alternatively, the actual seed spacing across multiple groups of seeds may be determined in some other manner. Block 702 may be followed by block 704.

At block 704, a seed spacing difference between the actual seed spacing and a target seed spacing may be determined. Block 704 may be followed by block 706.

At block 706, and in response to the seed spacing difference exceeding a seed spacing tolerance threshold, a rotational speed parameter may be adjusted based on the seed spacing difference to reduce future seed spacing differences between the target seed spacing and future actual seed spacings. The rotational speed parameter may determine actual seed spacing. In some embodiments, the seed spacing tolerance threshold is equal to a percentage. For instance, the seed spacing tolerance threshold may be equal to 3%. As an example, the adjustment to the rotational speed parameter may not be made unless the seed spacing difference is greater than 3% of the target rotational speed.

In these and other embodiments, an adjustment to the rotational speed parameter may be made automatically. Alternatively, the adjustment to the rotational speed parameter may be made only after suggesting the adjustment to the user through a user interface and receiving acceptance of the suggested adjustment from the user through the user interface.

One or more of the methods 400, 500, 600, and/or 700 may be implemented when a corresponding seed planter is stationary by simulating motion, e.g., by translating known distances to times by assuming motion at a target planting speed. In other embodiments, one or more of the methods 400, 500, 600, and/or 700 may be implemented when the corresponding seed planter is in motion and in operation to permit on the fly recalibration of one or more parameters, as needed.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The present disclosure is not to be limited in terms of the particular embodiments described herein, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that the present disclosure is not limited to particular methods, reagents, compounds, compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A method to calibrate a research seed planter, the method comprising:
transferring seeds through the research seed planter;
automatically measuring, using the research seed planter and without requiring a user to make manual measurements, at least one of the following: an actual first seed elapsed time; an actual last seed elapsed time; or an actual seed spacing between seeds; and
adjusting, based on the automatically measuring, a calibration parameter of the research seed planter that contributes to seed placement by the research seed planter.

2. The method of claim 1, wherein:
the transferring, the automatically measuring, and the calibrating includes transferring, automatically measuring, and calibrating all while the research seed planter is stationary; and
transferring seeds through the research seed planter includes transferring seeds from a staging gate through a seed transfer path to exit from a drop tube of the research seed planter.

3. The method of claim 1, wherein adjusting the calibration parameter that contributes to seed placement by the research seed planter comprises adjusting at least one of: a first seed pickup delay parameter, an evacuation startup delay parameter, an evacuation duration parameter, or a rotational speed parameter of the research seed planter and wherein transferring seeds through the research seed planter comprises transferring a first group of seeds through the research seed planter, the method further comprising:
sending a command to open a staging gate of the research seed planter a first seed lead duration in advance of a target first seed drop time, wherein the first seed lead duration depends on an expected seed transfer duration to transfer a seed through a seed transfer path of the research seed planter and on the first seed pickup delay parameter;
opening the staging gate to transfer the first group of seeds from a seed staging area to the seed transfer path, wherein the automatically measuring comprises automatically measuring the actual first seed elapsed time to drop a first seed of the first group of seeds from the seed transfer path; and
determining a difference between a target first seed elapsed time and the actual first seed elapsed time, wherein the adjusting comprises adjusting the first seed pickup delay parameter based on the difference between the target first seed elapsed time and the actual first seed elapsed time.

4. The method of claim 3, further comprising:
sending a command to evacuate excess seeds of a second group of seeds from one or more locations in the seed transfer path;
evacuating the excess seeds of the second group of seeds from the one or more locations in the seed transfer path, wherein the automatically measuring further comprises automatically measuring the actual last seed elapsed time to drop a last seed of the second group of seeds from the seed transfer path; and
determining a difference between a target last seed elapsed time and the actual last seed elapsed time, wherein the adjusting further comprises adjusting, based on the difference between the target last seed elapsed time and the actual last seed elapsed time, the evacuation startup delay parameter to reduce future differences between the target last seed elapsed time and future actual last seed elapsed times and wherein the evacuation startup delay parameter directly contributes to actual last seed elapsed times.

5. The method of claim 4, further comprising:
sending the command to evacuate excess seeds of a third group of seeds from the one or more locations in the seed transfer path;
sending a command to terminate evacuation of the excess seeds;
evacuating the excess seeds of the third group of seeds from the one or more locations in the seed transfer path until the command to terminate the evacuation of the excess seeds is implemented, wherein a duration of time between sending the command to evacuate the excess seeds of the third group of seeds and sending the command to terminate evacuation is equal to an evacuation duration parameter and wherein the automatically measuring comprises automatically measuring an actual last seed elapsed time to drop a last seed of the third group of seeds from the seed transfer path; and
determining a difference between the target last seed elapsed time and the actual last seed elapsed time of the third group of seeds, wherein the adjusting further comprises adjusting the evacuation duration parameter.

6. The method of claim 5, wherein the automatically measuring further comprises automatically determining actual seed spacing between seeds in the second group of seeds and between seeds in the third group of seeds, the method further comprising:
determining a seed spacing difference between the actual seed spacing and a target seed spacing,
wherein the adjusting further comprises adjusting, based on the seed spacing difference, the rotational speed parameter to reduce future seed spacing differences between the target seed spacing and future actual seed spacings, wherein the rotational speed parameter determines actual seed spacing.

7. A research seed planter, comprising:
a seed staging area;
a seed transfer path;
a staging gate that selectively separates the seed staging area from the seed transfer path;
a seed sensor configured to sense seeds that drop from the seed transfer path; and
a processor communicatively coupled to the staging gate and the seed sensor and configured to perform or control performance of operations comprising:
transferring seeds through the seed the research seed planter, including opening the staging gate to transfer seeds from the seed staging area into the seed transfer path and transferring seeds through the seed transfer path;
automatically measuring, using at least the seed sensor and without requiring a user to make manual measurements, at least one of the following: an actual first seed elapsed time to drop a first seed of a first group of seeds from the seed transfer path; an actual last seed elapsed time to drop a last seed of a second group of seeds from the seed transfer path; or an actual seed spacing between seeds in one or more groups of seeds; and
adjusting, based on the automatically measuring, a calibration parameter of the research see planter that contributes to seed placement by the research seed planter.

8. The research seed planter of claim 7, further comprising a pneumatic system pneumatically coupled to the seed transfer path and communicatively coupled to the processor and configured to pneumatically evacuate remaining seeds of one or more groups of seeds from one or more locations in the seed transfer path responsive to a command from the processor.

9. The research seed planter of claim 7, wherein adjusting the calibration parameter that contributes to seed placement by the research seed planter comprises adjusting at least one of: a first seed pickup delay parameter, an evacuation startup delay parameter, an evacuation duration parameter, or a rotational speed parameter of the research seed planter, and wherein the operations further comprise:
sending a command to open the staging gate a first seed lead duration in advance of a target first seed drop time, wherein the first seed lead duration depends on an expected seed transfer duration to transfer a seed through the seed transfer path and on the first seed pickup delay parameter;
opening the staging gate to transfer the first group of seeds from the seed staging area to the seed transfer path, wherein the automatically measuring comprises automatically measuring the actual first seed elapsed time to drop the first seed of the first group of seeds from the seed transfer path; and
determining a difference between a target first seed elapsed time and the actual first seed elapsed time, wherein the adjusting comprises adjusting the first seed pickup delay parameter based on the difference between the target first seed elapsed time and the actual first seed elapsed time.

10. The research seed planter of claim 9, wherein the operations further comprise:
sending a command to evacuate excess seeds of the second group of seeds from one or more locations in the seed transfer path;
evacuating the excess seeds of the second group of seeds from the one or more locations in the seed transfer path, wherein the automatically measuring further comprises automatically measuring the actual last seed elapsed time to drop the last seed of the second group of seeds from the seed transfer path; and
determining a difference between a target last seed elapsed time and the actual last seed elapsed time, wherein the adjusting further comprises adjusting, based on the difference between the target last seed elapsed time and the actual last seed elapsed time, the evacuation startup delay parameter to reduce future differences between the target last seed elapsed time and future actual last seed elapsed times and wherein the evacuation startup delay parameter directly contributes to actual last seed elapsed times.

11. A method to calibrate a research seed planter, the method comprising:
sending a command to open a staging gate;
opening the staging gate to transfer a group of seeds from a seed staging area to a seed transfer path of the research seed planter;
measuring an actual first seed elapsed time to drop a first seed of the group of seeds from the seed transfer path;
determining a difference between a target first seed elapsed time and the actual first seed elapsed time;
adjusting, based on the difference, a first seed pickup delay parameter to reduce future differences between the target first seed elapsed time and future actual first seed elapsed times, wherein the first seed pickup delay parameter directly contributes to actual first seed elapsed times.

12. The method of claim 11, further comprising:
repeating the sending, the opening, the measuring, and the determining for each of N−1 additional groups of seeds to determine a total of N differences between the target first seed elapsed time and N actual first seed elapsed times; and
determining a standard deviation of the N differences;
wherein:
the adjusting occurs in response to the standard deviation being less than a tolerance threshold; and
the adjusting, based on the difference, includes increasing or decreasing a value of the first seed pickup delay parameter by an amount equal to an average of the N differences.

13. The method of claim 12, further comprising:
determining actual seed spacing between seeds in the second group of seeds;
determining a seed spacing difference between the actual seed spacing and a target seed spacing;
adjusting, based on the seed spacing difference, a rotational speed parameter to reduce future seed spacing differences between the target seed spacing and future actual seed spacings, wherein the rotational speed parameter determines actual seed spacing.

14. The method of claim 13, wherein determining the actual seed spacing comprises determining actual average seed spacing of N groups of seeds.

15. The method of claim 11, further comprising:
sending a command to evacuate excess seeds of a second group of seeds from one or more locations in the seed transfer path;
evacuating the excess seeds of the second group of seeds from the one or more locations in the seed transfer path;
measuring an actual last seed elapsed time to drop a last seed of the second group of seeds from the seed transfer path;
determining a difference between a target last seed elapsed time and the actual last seed elapsed time;
adjusting, based on the difference between the target last seed elapsed time and the actual last seed elapsed time, an evacuation startup delay parameter to reduce future differences between the target last seed elapsed time and future actual last seed elapsed times, wherein the evacuation startup delay parameter directly contributes to actual last seed elapsed times.

16. The method of claim 15, further comprising:
repeating the sending the command to evacuate excess seeds, the evacuating, the measuring the actual last seed elapsed time, and the determining the difference between the target last seed elapsed time and the actual last seed elapsed time for each of N−1 additional groups of seeds to determine a total of N differences between the target last seed elapsed time and N actual last seed elapsed times; and
determining a standard deviation of the N differences between the target last seed elapsed time and the N actual last seed elapsed times;
wherein:
the adjusting occurs in response to the standard deviation being less than a tolerance threshold; and
the adjusting, based on the difference, includes increasing or decreasing a value of the evacuation startup delay parameter by an amount equal to an average of the N differences.

17. The method of claim 15, further comprising:
sending the command to evacuate excess seeds of a third group of seeds from the one or more locations in the seed transfer path;
sending a command to terminate evacuation of the excess seeds;
evacuating the excess seeds of the third group of seeds from the one or more locations in the seed transfer path until the command to terminate the evacuation of the excess seeds is implemented, wherein a duration of time between sending the command to evacuate the excess seeds of the third group of seeds and sending the command to terminate evacuation is equal to an evacuation duration parameter;
measuring an actual last seed elapsed time to drop a last seed of the third group of seeds from the seed transfer path;
determining a difference between the target last seed elapsed time and the actual last seed elapsed time of the third group of seeds; and
adjusting the evacuation duration parameter.

18. The method of claim 17, further comprising:
repeating the sending the command to evacuate excess seeds, the sending the command to terminate the evacuation of excess seeds, the evacuating, the measuring the actual last seed elapsed time, and the determining the difference between the target last seed elapsed time and the actual last seed elapsed time for each of N−1 additional groups of seeds in addition to the third group of seeds to determine a total of N differences between the target last seed elapsed time and N actual last seed elapsed times; and
determining a standard deviation of the N differences between the target last seed elapsed time and the N actual last seed elapsed times;
wherein:
the adjusting occurs in response to the standard deviation being less than a tolerance threshold; and
the adjusting includes:
decreasing a value of the evacuation duration parameter in response to an average of the N actual last seed elapsed times being within the tolerance threshold from the target last seed elapsed time; and
increasing the value of the evacuation duration parameter in response to the average of the N actual last seed elapsed times being greater than the target last seed elapsed time by an amount greater than the tolerance threshold.

19. The method of claim 18, further comprising:
repeating the determining the standard deviation of N differences between the target last seed elapsed time and N actual last seed elapsed times for K sets of N groups of seeds;
adjusting the evacuation duration parameter after determining the standard deviation of the N differences for K sets of N groups of seeds, including:
decreasing a value of the evacuation duration parameter in response to an average of the N actual last seed elapsed times for a corresponding one of the K sets being within the tolerance threshold from the target last seed elapsed time; and
increasing the value of the evacuation duration parameter in response to the average of the N actual last seed elapsed times for the corresponding one of the K sets being greater than the target last seed elapsed time by an amount greater than the tolerance threshold.

20. The method of claim 19, wherein:
the decreasing includes decreasing the value of the evacuation duration parameter by a fixed amount each time it is decreased or by half the current value each time it is decreased; and
the increasing includes increasing the value of the evacuation duration parameter back to an immediately preceding value plus a buffer amount.
